(19) United States
(12) Patent Application Publication
(10) Pub. No.: US 2015/0312708 A1
(43) Pub. Date: Oct. 29, 2015

(54) REMOTE TRACKING ARROW

(71) Applicant: Joshua Helmer, Pine City, MN (US)

(72) Inventor: Joshua Helmer, Pine City, MN (US)

(21) Appl. No.: 14/262,168

(22) Filed: Apr. 25, 2014

(51) Int. Cl. H04W 4/02; A01K 11/00

(52) U.S. Cl. CPC H04W 4/02; A01K 11/008

(57) ABSTRACT

The remote tracking arrow comprises an arrow body and an arrow head arranged in a conventional arrow arrangement. The arrow body is configured as a conventional arrow body except that it includes a sensor assembly on its end which is adjacent to the conventional arrow head. The sensor assembly is defined by a permanent sensor integrated into the arrow body and connected to a detachable sensor which is removably attached to the exterior of the arrow body. In operation, when the remote tracking arrow is shot and enters a targeted animal (whether passing through or not), the detachable sensor will contact the bodily fluid of the animal and adhere thereto, causing at least a portion thereof to detach from the arrow body. Once detached, both the detached portion of detachable sensor and the permanent sensor, activate, enabling them to be separately tracked by a geolocation receiver.

### BACKGROUND OF THE INVENTION

1. Field of the Invention

This invention relates generally to hunting devices and, more particularly, to a remote tracking arrow for use in bow hunting for enabling an arrow and a target to be located and recovered.

2. Description of the Prior Art

Bowhunting (or bow hunting) is a well known practice of hunting game animals by archery. While bowhunting, hunters commonly either track a target by still hunting, following it from an upwind position to get into a position to shoot or by stand hunting, waiting for the target to come to him. A problem which still exists, however, is that after shooting a target animal with an arrow, the hunter often has difficulty with locating the targeted prey, particularly near waterways or within dense woods where visibility is low. Thus, there remains a need for a remote tracking arrow configured with sensors that enable the arrow and a target to be tracked from a distance. It would be helpful if such a remote tracking arrow was configured to operate in conjunction with a remote GPS locating receiver to assist in the recovering the arrow and the target. It would be additionally desirable for such a remote tracking arrow to be mechanically activated by action of the arrow striking the target animal.

The Applicant's invention described herein provides for an arrow adapted to be located by a GPS locating device to enable it, as well as the target animal struck therewith, to be tracked and recovered. The primary components in Applicant's remote tracking arrow are a base arrow, a plurality of sensors, and a tracking system. When in operation, the remote tracking arrow enables bowhunting hunters to locate their arrows after they have been used for their specified marks and recover the mark animal without following blood or other tracking trails. As a result, many of the limitations imposed by prior art structures are removed.

### SUMMARY OF THE INVENTION

A remote tracking arrow for tracking and retrieving an arrow and an animal targeted with the same. The remote tracking arrow comprises a modified arrow body and an arrow head arranged in a conventional arrow arrangement. The modified arrow body is configured as a conventional arrow body except that it includes a sensor assembly on its end which is adjacent to the conventional arrow head. The sensor assembly is defined by a permanent sensor integrated into the modified arrow body and connected to a detachable sensor which is removably attached to the exterior of the modified arrow body.

In operation, when the remote tracking arrow is shot and enters a targeted animal (whether passing through or not), the detachable sensor will contact the bodily fluid of the animal and adhere thereto, causing at least a portion thereof to detach from the modified arrow body. Once detached, both the detached portion of detachable sensor and the permanent sensor, activate, enabling them to be separately tracked by a geolocation receiver.

It is an object of this invention to provide an extension bar for a remote tracking arrow configured with sensors that enable the arrow and a target to be tracked from a distance.

It is another object of this invention to provide a remote tracking arrow configured to operate in conjunction with a remote GPS locating receiver to assist in the recovering the arrow and the target.

It is yet another object of this invention to provide a remote tracking arrow to mechanically activated by action of the arrow striking the target animal.

These and other objects will be apparent to one of skill in the art.

### BRIEF DESCRIPTION OF THE DRAWINGS

FIG. 1 is a side elevational view of a remote tracking arrow built in accordance with the present invention.

FIG. 2 is a front elevational view of a cross section of the detachable tracking member of a remote tracking arrow built in accordance with the present invention.

### DETAILED DESCRIPTION OF THE INVENTION

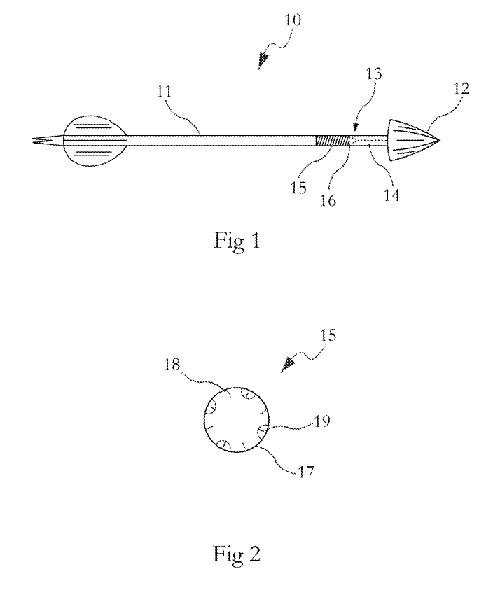

Referring now to the drawings and in particular FIGS. 1 and 2, a remote tracking arrow 10 is shown as a modified arrow body 11 and an arrow head 12 arranged in a conventional arrow arrangement. The modified arrow body 11 is constructed of similar materials as conventional arrow bodies and is configured as a conventional arrow body except that it includes a sensor assembly 13 on its end which is adjacent to the arrow head 12. The arrow head 12 is configured as conventional arrow heads and attached to the modified arrow body 11 as arrow heads are conventionally attached to arrow bodies.

The sensor assembly 13 is defined by a permanent sensor 14 integrated into the modified arrow body 11 and a detachable sensor 15 which is removably attached to the exterior of the modified arrow body 11. The permanent sensor 14 and the detachable sensor 15 are additionally connected to each other through an electrical wire 16. The wire connection between the permanent sensor 14 and the detachable sensor 15 enables the permanent sensor 14 and the detachable sensor 15 to each sense when any part of the detachable sensor 15 has become disconnected from the permanent sensor 14 and thus detached from the modified arrow body 12.

The detachable sensor 15 is defined by a thin film body 17 which encircles the modified arrow body 11, with its interior surface being removably attached to the exterior surface of the modified arrow body 11. In the preferred embodiment, the film body 17 is attached to the modified arrow body 11 through an adhesive. The exterior surface of the film body 17 is defined by a moisture activated, permanent adhesive. The film body 17 includes four contact points 18 and four tracking assemblies 19. The contact points 18 are each disposed over a perforated section of the film body 17 and are the location on the film body 17 which receives the wire 16 from the permanent sensor 14. The tracking assemblies 19 are each independently operating tracking devices which include a geolocation transmitter and a battery to provide power to the geolocation transmitter when the geolocation transmitter has been activated. In the preferred embodiment, the geolocation transmitter is a GPS transmitter. The tracking assemblies 19 are each releaseably attached to one contact point 18 and configured so that when the connection between the permanent sensor 14 and that particular contact point 15 is removed, the geolocation transmitter in that tracking assembly 19 activates.

In operation, when the remote tracking arrow 10 is shot and enters a targeted animal (whether passing through or not), it is contemplated that at least a portion of the detachable sensor 15 will contact the bodily fluid of the animal. This will cause the permanent adhesive on that area of the detachable sensor 15 to stick to the part of the animal's body substantially at the location where the fluid was contacted, detaching from the modified arrow body 11 in the process. This will cause the contact point 18 of the detached area to be broken as the arrow body 11 continues to move through the animal. Once at least one contact point 18 is broken, both the tracking assembly 19 associated with any broken contact point 18 and the permanent sensor 14, which also contains a geolocation transmitter and a battery to provide power to the geolocation transmitter, activate. The activated tracking assembly 19, as well as the geolocation transmitter in the permanent sensor can then be tracked though a conventional geolocation receiver, such as a GPS device or a smartphone having GPS receiver hardware and software thereon.

In the preferred embodiment, the geolocation receiver is paired with the tracking assemblies 19 and the permanent sensor 14 of a remote tracking arrow 10 prior to use. In such embodiments, activated tracking assemblies 19 would have a distinct appearance on the screen of the geolocation receiver than that of the permanent sensor 14, enabling a user attempting to track an animal struck with a remote tracking arrow 10 to distinguish the permanent sensor 14, which may have passed through the animal, and the activated geolocation transmitter disposed on the detached portion of the tracking assembly 19.

In an alternate embodiment, each tracking assembly 19 additionally includes a sensor which enables the remote detection of an animal's body temperature and heart rate. In such an embodiment, the permanent sensor 14 additionally includes an additional sensor which enables the determination of ambient conditions (wind speed, temperature) and shooting statistics of the arrow (maximum speed shot, distance traveled).

The instant invention has been shown and described herein in what is considered to be the most practical and preferred embodiment. It is recognized, however, that departures may be made therefrom within the scope of the invention and that obvious modifications will occur to a person skilled in the art.

1. A remote tracking arrow, comprising:
a modified arrow body having a distal end;
an arrow head, wherein said arrow head is extends from the distal end of said arrow body;
a sensor assembly defined by a permanent sensor communicatively attached to at least one detachable sensor and disposed adjacent to said distal end of said arrow body, wherein said permanent sensor is integrated into said arrow body and said detachable sensor is removably attached to the exterior surface of said arrow body;
wherein said detachable sensor includes a power source and a detachable geolocation transmitter configured to enable the detachable sensor to transmit location information to a remote device;
wherein said permanent sensor includes a power source and a permanent geolocation transmitter configured to enable the permanent sensor to transmit location information to a remote device; and
wherein said detachable geolocation transmitter and said permanent geolocation transmitter are activated by the breaking of the communicative attachment between the permanent sensor and the detachable sensor.

2.-3. (canceled)

4. The remote tracking arrow of claim 1, wherein said detachable geolocation transmitter and said permanent geolocation transmitter are defined by a GPS transmitter.

5. The remote tracking arrow of claim 1, wherein said detachable geolocation transmitter and said permanent geolocation transmitter are defined by a cellular geolocation device.

6. The remote tracking arrow of claim 1, wherein said detachable sensor is configured to attach to the flesh of an animal when the distal end of the arrow body enters the animal.

7. The remote tracking arrow of claim 6, wherein said detachable sensor is configured to attach to the flesh of an animal through a moisture activated, permanent adhesive disposed on its exterior surface.
